(19) United States
(12) Patent Application Publication
(10) Pub. No.: US 2005/0005953 A1
(43) Pub. Date: Jan. 13, 2005

(54) Installation for treating semiconductor wafers

(76) Inventor: Michel Poulenard, Voreppe (FR)

Correspondence Address: WINSTON & STRAWN;PATENT DEPARTMENT, 1400 L STREET, N.W., WASHINGTON, DC, 20005-3502, US

(21) Appl. No.: 10/663,545

(22) Filed: Sep. 15, 2003

(30) Foreign Application Priority Data
Jul. 9, 2003 (FR) 0308392

(51) Int. Cl. B08B 3/04

(52) U.S. Cl. 134/61; 134/76; 134/78; 134/137; 134/147; 134/158; 134/902

(57) ABSTRACT

An improved installation for treating semiconductor wafers is described. The installation includes a tank adapted to contain a treatment bath and equipped with a wafer-holding device capable of receiving at least one wafer of a first size, and a gripping element for grasping each wafer of the first size and for placing it into and removing it from the tank. Also included is a support adapter for receiving wafers of a second size smaller than the first size, the support adapter having a structure that permits it to be grasped directly by the gripping element and held by the wafer-holding device. At least one rotation-blocking element prevents the support adapter from rotating relative to the wafer-holding device when the support adapter is positioned in the wafer-holding device.

### BACKGROUND ART

This invention generally relates to the field of microelectronics. It relates more particularly to the field of installations for chemically treating wafers of a semiconductor material that are used as substrates for fabricating microelectronic components in such fields as optics and optronics.

Installations of this type are already known, and typically include a tank designed to contain a treatment bath. The installations are equipped with wafer-holding means capable of receiving at least one wafer of a first size. Also included is a gripping means capable of grasping each wafer of the first size, in order to place it into and remove it from the tank.

U.S. Pat. No. 6,576,065 describes an improved installation that further includes a support for receiving wafers of a second size smaller than the first size. The support has a geometry such that it can be grasped directly by the gripping means and held by the wafer-holding means. The support thus serves as an adapter for the wafers of the second size, which can be treated in the installation without requiring any other specific equipment. Such a support shall hereinafter be designated in this text by the term “support adapter”.

In this type of installation, the support adapter may include two plates that have substantially the same shape of a wafer of the first size. The plates are joined together by support means for the wafers of the second size. Consequently, the plates can be received and seated in the wafer-holding means and handled by the gripping means. It is noted, however, that it is possible for the support adapter to turn around its longitudinal axis in relation to the wafer-holding means. Such a rotation of the support adapter can impede the wafers from being properly held in place in the installation.

In addition, the above-described support means (which are typically made in the form of rods that include slots for receiving and holding the wafers of the second size) are screwed into the plates in order to form a rigid whole. Thus, each end of the support means abuts against the surface of a plate, and a screw passes through the plate in order to be driven into the support means. It may be possible to further improve this method of fastening the support means and plates, in particular in order to make the support adapter even sturdier and more wear-resistant.

Finally, the slots in the support means are generally made with a “double cone-shaped” section having a profile consisting of a first “V” in its part adjacent to the opening of the slot, and a second “V” towards the bottom of the slot. The first “V” corresponds to an angle of approximately 60°, while the second “V,” which constitutes the bottom of the slot, corresponds to an angle of approximately 30°. It has been observed that such a slot profile might be associated with slippage of the wafers of the second size. Such slippage may cause scratches on the surface of the wafers, which are detrimental. Thus, it would be beneficial to further improve upon known semiconductor treatment installations, especially with regard to the three aspects mentioned above.

### SUMMARY OF THE INVENTION

In order to solve the problems identified above, the invention provides an improved installation for treating semiconductor wafers. An installation according to a first aspect of the invention includes a tank adapted to contain a treatment bath and equipped with a wafer-holding device capable of receiving at least one wafer of a first size, and a gripping element for grasping each wafer of the first size and for placing it into and removing it from the tank. A support adapter is included for receiving wafers of a second size smaller than the first size, the support adapter having a structure that permits it to be grasped directly by the gripping element and held by the wafer-holding device. At least one rotation-blocking element is provided that prevents the support adapter from rotating relative to the wafer-holding device when the support adapter is positioned in the wafer-holding device.

In an advantageous variant, the rotation-blocking element includes at least one shaped feature of the support adapter that cooperates with a shaped feature of the wafer-holding device. In an implementation, the support adapter has an overall circular shape that corresponds to the contour of a wafer of the first size and includes at least one protruding element that cooperates with a limit stop of the wafer-holding device. The support adapter may have an overall U-shape including a generally circular first part that corresponds to the shape of a wafer of the first size, and including straight portions that cooperate with a limit stop of the wafer-holding device. In addition, the limit stop of the wafer-holding device may consist of at least one discrete element, such as a shoulder.

Another advantageous embodiment of an installation for treating semiconductor wafers includes a tank adapted to contain a treatment bath and equipped with a wafer-holding device capable of receiving at least one wafer of a first size, and a gripping element for grasping each wafer of the first size and for placing it into and removing it from the tank. A support adapter for receiving wafers of a second size smaller than the first size is also included. The support adapter has a structure that permits it to be grasped directly by the gripping element and held by the wafer-holding device. The support adapter includes two plates shaped so that at least one portion of each plate is substantially similar to that of a wafer of the first size, and includes support elements fixed to the plates to join them together, wherein the support elements are capable of holding a batch of wafers of the second size.

An advantageous variation further includes cooperating elements associated with the support elements and the plates that prevent rotation of the support elements in relation to the plates. In an implementation, the cooperating elements include recesses in the plates and substantially similarly shaped end portions of the support elements. The support elements may also advantageously include slots capable of holding a batch of wafers of the second size, and the slots may have a V-shaped profile that forms a single angle. In a preferred embodiment, the single angle has a value ranging from between about 40° to about 60°, and in a particular implementation the single angle is 45°.

Another embodiment of the invention concerns a support adapter for use in an installation for treating semiconductor wafers of a first size and wafers of a second, smaller size, wherein the support adapter has a structure that permits it to be grasped directly by a gripping element and held by a wafer-holding device. The support adapter includes two plates shaped so that at least one portion of each plate is substantially similar to that of a wafer of the first size, and a plurality of support elements fixed to the plates to join them together, the support elements capable of holding a batch of wafers of the second size. The support adapter also includes at least one rotation-blocking element for preventing the support adapter from rotating relative to the wafer-holding device when the support adapter is positioned in the wafer-holding device.

### BRIEF DESCRIPTION OF THE DRAWINGS

Other aspects, purposes and advantages of the invention will become clear after reading the following description with reference to the attached drawings, in which:

FIG. 1 schematically represents the conventional transfer of wafers from a storage box to a support adapter.

FIG. 2 schematically represents a typical method of using a treatment installation.

FIGS. 3a and 3b are respective front elevational and side views of a support adapter used in an installation according to a first aspect of the invention.

FIG. 3c is an elevational view of a variant of a support adapter used in an installation according to the same aspect of the invention.

FIGS. 4a and 4b are respective front elevational and side views of a gripping plate of the support adapter of FIG. 3c.

FIGS. 5a to 5d are views of an embodiment of a rod of a support adapter according to the invention, the rod serving as a support means for the wafers. In particular, FIG. 5a is a side view of the rod, FIG. 5b is a front view of the rod, FIG. 5c is a rear view of the rod, and FIG. 5d is a partial side view detail of the rod.

FIGS. 6a to 6c are three views of another implementation of a structural element of a support adapter according to the invention.

### DETAILED DESCRIPTION OF THE PREFERRED EMBODIMENTS

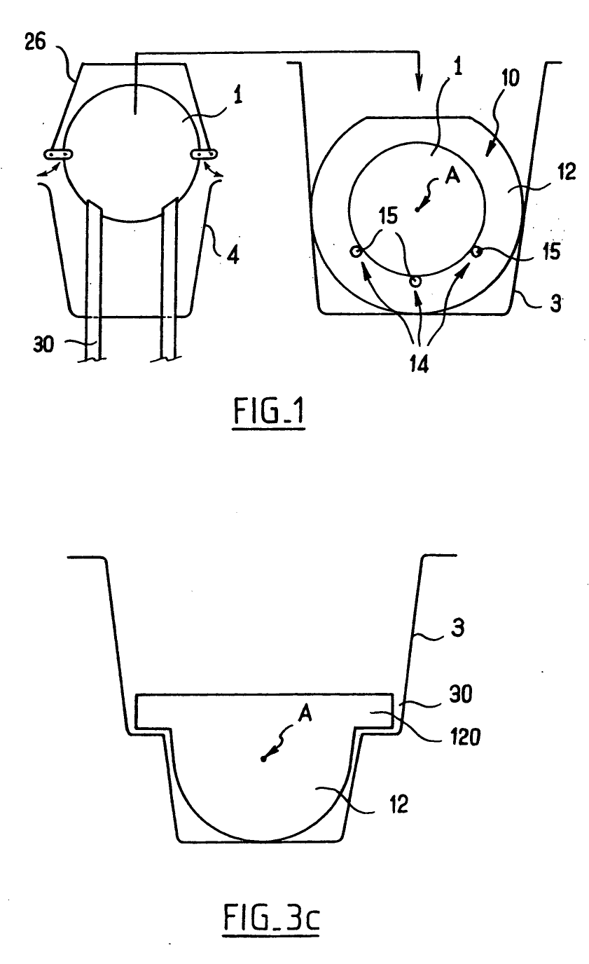

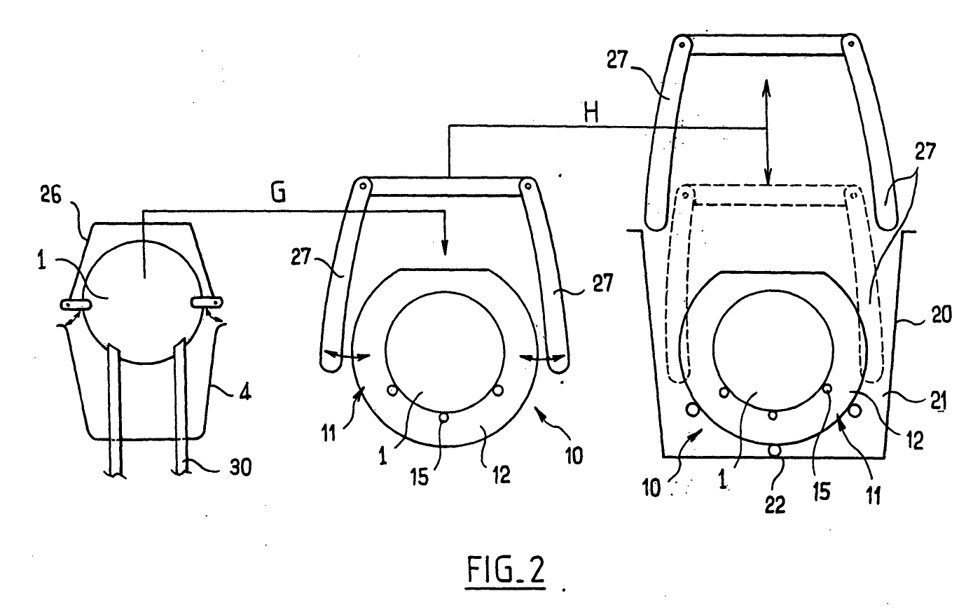

FIGS. 1 and 2 schematically represent various aspects of a typical installation for treating wafers. In particular, FIG. 1 schematically represents a conventional transfer system 30 making it possible to remove wafers 1 of a given diameter from a handling and storage box 4. The transfer means 26 are capable of engaging with the wafers 1, and of moving them in order to deposit them into a support adapter 10.

The support adapter 10 can be deposited into a second handling and storage box 3, which can itself be arranged inside another box, for example, while awaiting a chemical treatment of the wafers 1. The support adapter 10 includes two end plates 12 whose contour corresponds substantially to the contour of a wafer. The end plates may have a diameter larger than the diameter of the wafers 1 (one of these two referenced plates being shown in FIG. 1). These plates are called “gripping plates” because they enable the support adapter to be handled by the gripping means. Also included are rods 15 forming support means for the wafers 1, the rods joining together the two plates 12 so as to form a rigid whole. The contour of the plates of the support adapter 10 thus defines a first size, which corresponds to the size of the wafers capable of being held, for example, inside the box 3. The wafers 1 define a second size, smaller than the first size.

FIG. 2 illustrates a method of using a treatment installation. The illustrated method includes two principal steps designated G and H. During the course of step G, the wafers 1 of the second size are transferred from a handling and storage box 4 to a support adapter 10, with the help of the transfer means 26, 30. Transfer combs 27, originally designed to grasp and move wafers of the first size, then engage with the plates 12 of the support adapter 10, in order to raise and move this support adapter towards a chemical treatment or rinsing tank 20. The support adapter 10 has a characteristic dimension (diameter of the round section of its plates 12) which corresponds to the first size. Next, either the operations G and H are carried out in reverse order to arrange the wafers 1 in handling and storage boxes 4, or the support adapter 10 is moved into a new tank to undergo another chemical treatment or rinsing. In FIGS. 1 and 2, which illustrate a known type of installation, it is noted that the contour of the plates 12 includes a substantial portion of a circle.

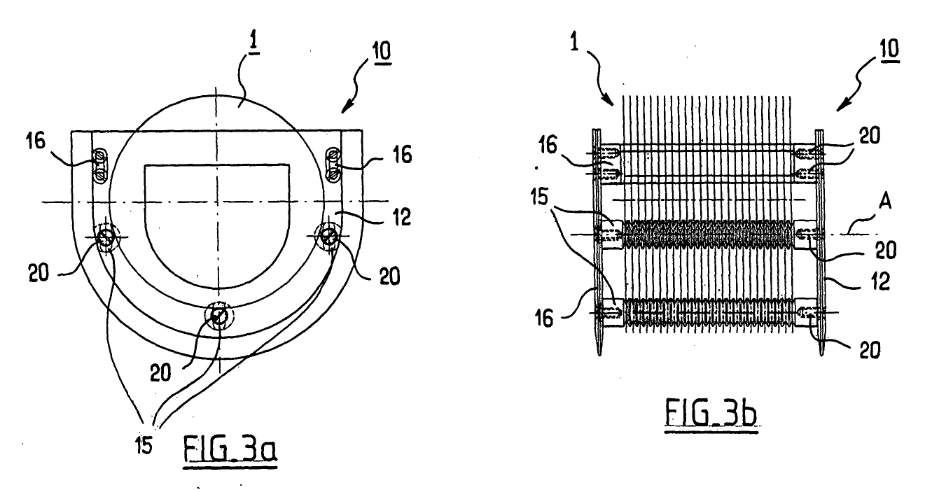

Referring now to FIGS. 3a and 3b, a support adapter of a treatment installation is illustrated according to a first aspect of the invention. This support adapter 10 is capable of receiving wafers 1. In this embodiment, the wafers 1 correspond to a “second size” that is smaller than the “first size” of the support adapter 10 itself. The support adapter 10 is intended to be used in an installation for treating wafers of a semiconductor material. Such an installation includes, in addition to the support adapter, a tank designed to contain a treatment bath and equipped with a wafer-holding device or means capable of receiving at least one wafer of the first size. Also included is a gripping element or means capable of grasping each wafer of the first size in order to place it into and remove it from the tank. The support adapter 10 shown in FIGS. 3a and 3b may thus be used with an installation of the type shown in FIG. 2. The support adapter 10 is preferably made of a PVDF-type material (polyvinylidene fluoride).

The support adapter 10 comprises two plates 12 that are joined together by support means 15 and that are capable of holding a batch of wafers 1 (see FIG. 3b). The support adapter 10 includes three rods 15 which are provided with slots that form seats for receiving the wafers. More specifically, it is to be noted in FIG. 3a that the shape or contour of the plates 12 of the support adapter 10 does not merely correspond to a portion of a circle, as shown in the drawings of FIGS. 1 and 2. On the contrary, according to a first aspect of the invention, the treatment installation includes a rotation-blocking element or means that prevents the support adapter from rotating in relation to the tank's wafer-holding device, when the support adapter is positioned in the wafer-holding device. The rotation-blocking elements are preferably produced by ensuring that the shape of the support adapter and wafer-holding means cooperate with each other. In particular, it is possible for the support adapter to have an overall circular shape or contour corresponding to the shape of a wafer of the first size, with at least one element protruding from that shape or contour that cooperates with a limit stop of the wafer-holding means.

In FIG. 3a, the shape of the support adapter, which is defined by the contour of the plates 12, has an overall “U” shape. The support adapter includes an overall circular first part corresponding to the contour of a wafer of the first size, and a second part having straight sides capable of cooperating with limit stops of the tanks' wafer-holding device. In this embodiment, the tank's wafer-holding device has a contour that complements that of the plates 12 (i.e. a “U-shaped” contour). In this case, the limit stops of the wafer-holding device are continuous straight surfaces (corresponding to the two straight sides of the “U”). It is likewise possible for the limit stops of the wafer-holding device to be made up of discrete elements, for example, a shoulder that forms a cavity or cavities in the wall of the wafer-holding device. The shoulder would then receive a complementary part or parts protruding from the contour of at least one of the plates 12.

FIG. 3c thus represents an implementation of a plate 12 of a support adapter 10 whose shape or contour is defined by a portion of a circle surmounted by a cross-bar 120 protruding from both sides of the circular shape. The cross-bar 120 is capable of becoming lodged inside complementary shoulders 30 of the tank 3. This arrangement prevents the support adapter from rotating about its longitudinal axis A when seated inside of the tank's wafer-holding device.

Referring again to FIGS. 3a and 3b, the support adapter 10 also includes two rods 16 referred to as “detection rods” in addition to the three rods 15 that join the two plates 12 together. Like rods 15, each of these two detection rods is fastened to both plates 12.

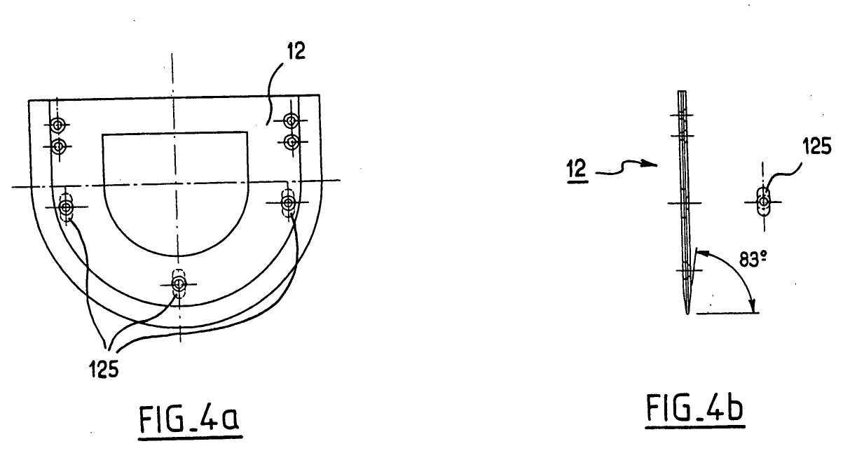

Referring now to FIGS. 4a and 4b, these drawings more specifically show a plate 12 of a support adapter for use in an installation according to the first aspect of the invention. A “U-shaped” plate contour is again shown in FIG. 4a. Also shown in FIG. 4a is the particular configuration of the three fasteners 125 for the rods (or support means) 15. In the implementation shown, each fastener 125 is actually formed as a recess in the plate 12 for receiving the rods to be fixed into the plates. More precisely, the cooperating parts of the rods and plates are shaped to prevent any rotation of the rods in relation to the plates. Thus, in the drawing of FIG. 4a, the recesses are shown as having an elongated shape. In general, these recesses may have a contour that produces salient angles or outward angles. The cross section of the end of a rod, which is fixed into the plate, thus has a contour or shape that is substantially similar or identical to that of the recess of the plate, or within a close tolerance.

In FIGS. 3a and 4a, it is noted that provision is also made for the rods 15 that are fixed into the plates 12 to be secured in place with screws 20. Each of these screws 20 may be associated with a part coming to bear against the face of the plate 12 opposite the rods 15. This part may be a separate washer or an enlarged part of the screw head. Each screw is thus screwed into a corresponding rod 15, along the longitudinal axis of the rod, through a corresponding recess 125 of the plate 12.

In FIG. 4b, it is noted that the edge of the plate has a reduced thickness. The reduced thickness edge enables the plate to be held inside the wafer-holding device (which typically comprise slots designed to receive wafers of the first size). For example, for a support adapter with a diameter of about five inches, it is possible to anticipate a maximum thickness of about 5 mm for the plate, and a peripheral thickness of about 1.5 mm. Thus, the peripheral part of the plate may have a beveled profile, having an angle to a surface on the order of about 83°, as shown in FIG. 4b.

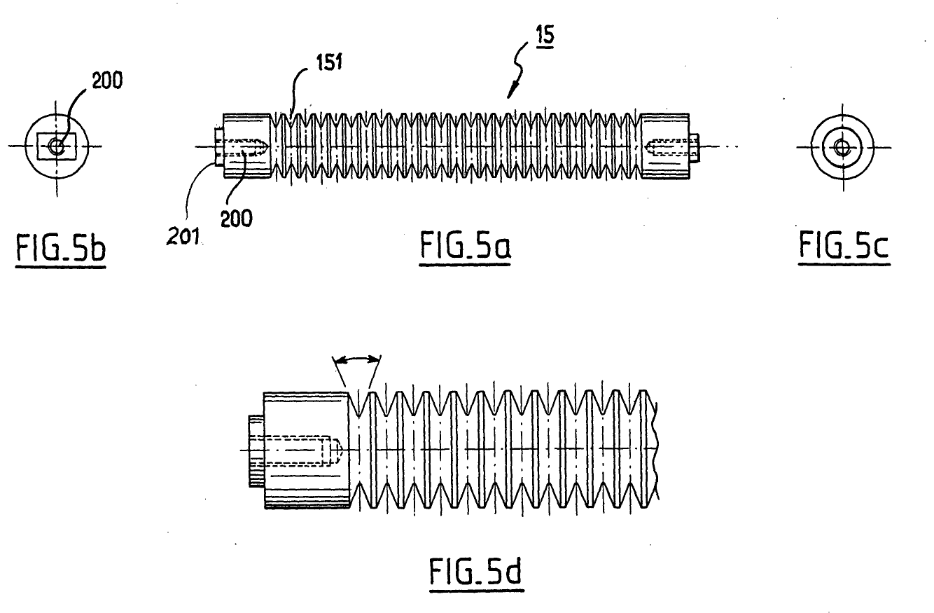

Referring to FIGS. 5a to 5d, a more detailed drawing has been made of a first embodiment of a rod (or support means) 15 making it possible to form a support adapter 10. The rod includes a series of slots 151 evenly spaced apart along its length. The slots have a “V-shaped” profile, the walls of the slots forming a single angle. This arrangement makes it possible to prevent the wafers from slipping, and thus to prevent any possible scratches that might ensue. The angle formed by the “V” of the slots preferably has a value ranging from between about 40° to about 60°. It has been determined that an angle on the order of about 45° makes it possible to hold the wafers in place in a particularly efficient manner. More precisely, an angle of 45° makes it possible to obtain a particularly efficient seat to hold the wafers.

FIG. 5b represents a front view of the rod, with its associated thread 200 for receiving a fastening screw for a plate 12. In FIGS. 5a to 5c, it is noted that only one end of the rod is equipped with a shaped element that prevents any rotation of the rod in relation to the plates. In the case of these figures, the shaped element corresponds to a rectangular shoulder 201 that is rigidly fastened to the end of the rod and that is designed to fit in a fixed manner into a complementary, rectangular-shaped recess of one of the plates 12. It is obviously possible to provide such a means or element at both ends of the rod 15.

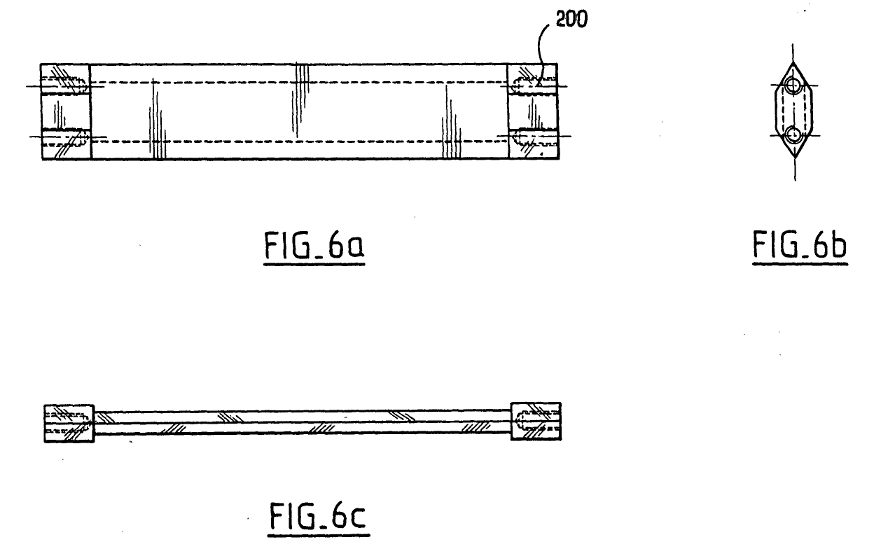

Finally, FIGS. 6a to 6c show an implementation of one of the detection rods of the support adapter 10, with the recesses 200 arranged to receive screws 20 for fastening to the plates 12.

1. An installation for treating semiconductor wafers comprising:
a tank adapted to contain a treatment bath and equipped with a wafer-holding device capable of receiving at least one wafer of a first size;
a gripping element for grasping each wafer of the first size and for placing it into and removing it from the tank;
a support adapter for receiving wafers of a second size smaller than the first size, the support adapter having a structure that permits it to be grasped directly by the gripping element and held by the wafer-holding device; and
at least one rotation-blocking element for preventing the support adapter from rotating relative to the wafer-holding device when the support adapter is positioned in the wafer-holding device.

2. The installation of claim 1 wherein the rotation-blocking element comprises at least one shaped feature of the support adapter that cooperates with a shaped feature of the wafer-holding device.

3. The installation of claim 2 wherein the support adapter has a circular shape that corresponds to the contour of a wafer of the first size and includes at least one protruding element that cooperates with a limit stop of the wafer-holding device.

4. The installation of claim 2 wherein the support adapter is U-shaped and includes a generally circular first part that corresponds to the shape of a wafer of the first size, and includes straight portions that cooperate with a limit stop of the wafer-holding device.

5. The installation of claim 3 wherein the limit stop of the wafer-holding device includes at least one discrete element.

6. The installation of claim 5 wherein the limit stop comprises a shoulder.

7. The installation of claim 1 wherein the support adapter comprises two plates shaped so that at least one portion of each plate is substantially similar to that of a wafer of the first size, and support elements fixed to the plates that are capable of holding a batch of wafers of the second size and that join the plates together.

8. An installation for treating semiconductor wafers comprising:
a tank adapted to contain a treatment bath and equipped with a wafer-holding device capable of receiving at least one wafer of a first size;
a gripping element for grasping each wafer of the first size and for placing it into and removing it from the tank, and
a support adapter for receiving wafers of a second size smaller than the first size, the support adapter having a structure that permits it to be grasped directly by the gripping element and held by the wafer-holding device, the support adapter including two plates shaped so that at least one portion of each plate is substantially similar to that of a wafer of the first size, and including support elements fixed to the plates to join them together, wherein the support elements are capable of holding a batch of wafers of the second size.

9. The installation of claim 8 further comprising cooperating elements associated with the support elements and the plates that prevent rotation of the support elements in relation to the plates.

10. The installation of claim 9 wherein the cooperating elements comprise recesses in the plates and substantially similarly shaped end portions of the support elements.

11. The installation of claim 8 further comprising slots in the support elements capable of holding a batch of wafers of the second size.

12. The installation of claim 11 wherein the slots have a V-shaped profile that forms a single angle.

13. The installation of claim 12 wherein the single angle has a value ranging from between about 40° to about 60°.

14. The installation of the claim 13 wherein the single angle is approximately 45°.

15. A support adapter for use in an installation for treating semiconductor wafers of a first size and wafers of a second, smaller size, the support adapter having a structure that permits it to be grasped directly by a gripping element and held by a wafer-holding device, comprising:
two plates shaped so that at least one portion of each plate is substantially similar to that of a wafer of the first size;
a plurality of support elements fixed to the plates to join them together, the support elements capable of holding a batch of wafers of the second size; and
at least one rotation-blocking element for preventing the support adapter from rotating relative to the wafer-holding device when the support adapter is positioned in the wafer-holding device.

16. The support adapter of claim 15 wherein the rotation-blocking element comprises at least one shaped feature of the support adapter that cooperates with a shaped feature of the wafer-holding device.

17. The support adapter of claim 15 wherein the support adapter has an overall circular shape and includes a protruding rotation-blocking element that cooperates with a limit stop of the wafer-holding device.

18. The support adapter of claim 15 wherein the support adapter is U-shaped and includes a generally circular first part and straight portions that cooperate with a limit stop of the wafer-holding device.

19. The support adapter of claim 15 further comprising cooperating elements associated with the support elements and the plates that prevent rotation of the support elements in relation to the plates.

20. The support adapter of claim 19 wherein the cooperating elements comprise recesses in the plates and substantially similarly shaped end portions of the support elements.

21. The support adapter of claim 15 further comprising slots in the support elements capable of holding a batch of wafers of the second size.

22. The support adapter of claim 21 wherein the slots have a V-shaped profile that forms a single angle.

23. The support adapter of claim 22 wherein the single angle has a value ranging from between about 40° to about 60°.

24. The support adapter of the claim 22 wherein the single angle is approximately 45°.

25. The support adapter of claim 15 wherein the plates and support elements are made of a polyvinylidene fluoride material.

26. The support element of claim 15 further comprising at least one detection rod fastened between the plates.

27. The support element of claim 15 wherein each plate has a reduced thickness edge that enables the plate to be held inside the wafer-holding device.

28. The support element of claim 27 wherein the reduced thickness edge has a beveled profile.
